(19) United States
(12) Patent Application Publication
(10) Pub. No.: US 2023/0297081 A1
(43) Pub. Date: Sep. 21, 2023

(54) Automation system and method for controlling a production process in a production plant in the metal production industry, the non-ferrous industry or the steel industry for producing semi-finished products or finished products

(71) Applicant: SMS group GmbH, Düsseldorf (DE)

(72) Inventors: Christian GEERKENS, Jüchen (DE); Gerald MAYR, Bad Tölz (DE)

(73) Assignee: SMS group GmbH, Düsseldorf (DE)

(21) Appl. No.: 18/016,913

(22) PCT Filed: Jul. 12, 2021
(86) PCT No.: PCT/EP2021/069304

§ 371 Date: Jan. 19, 2023

(30) Foreign Application Priority Data
Jul. 21, 2020 (DE) 10 2020 209 143.9

(51) Int. Cl. G05B 19/418

(52) U.S. Cl. CPC G05B 19/41835; G05B 2219/31368

(57) ABSTRACT

An automation system (1) for controlling a production process in a production plant (2) in the metal production industry, the non-ferrous industry or the steel industry for producing semi-finished products or finished products comprising a plurality of plant parts (3) for carrying out separate production steps comprises, for each plant part (3), a separate control unit (4) for controlling actuators (5) and/or sensors (6) of the respective plant part (3) for the purpose of automating the production step in the respective plant part (3). The separate control units (4) of the automation system (1) comprise wireless communication means (7) for wirelessly communicating with one another.

### TECHNICAL FIELD

The disclosure relates to an automation system for controlling a production process in a production plant in the metal production industry, the non-ferrous industry or the steel industry for producing semi-finished products or finished products. The disclosure also relates to a method for controlling a production process in a production plant in the metal production industry, the non-ferrous industry or the steel industry for producing semi-finished products or finished products.

### BACKGROUND

The disclosure relates generally to a plant of the metallurgical industry, such as a plant in the metal production industry, the non-ferrous (NF) or steel industry or the master alloy production. Examples of such industrial plants include blast furnaces, direct reduction plants, electric arc furnaces, converters or plants for ladle processes, plants for primary or secondary metal forming such as continuous or billet casters and hot and/or cold rolling mills, or plants upstream or downstream of such plants such as furnaces, e.g. reheating or holding furnaces, straightening equipment, coating lines, cooling lines, pickling or annealing.

With automation systems known in the prior art for controlling a production process in a production plant in the metal production industry, the non-ferrous industry or the steel industry for producing semi-finished products or finished products, the actuators and/or sensors in the individual plant parts are connected via cabling to so-called remote input-outputs (RIOs). Thereby, the RIOs are connected to control cabinets via bus cabling. The open-loop and closed-loop functions are performed by so-called programmable logic controllers (PLC) or comparable hardware, which are located in the control cabinets. The setpoint return from the PLC or comparable hardware back to the actuators and/or sensors likewise takes place via the bus cabling. In addition to PLCs, third-party control systems, such as PCS7 from Siemens or Melody from ABB, are also used. Furthermore, so-called motion controllers from different manufacturers are used for highly dynamic applications, which motion controllers, as real-time capable systems, enable fast control down to 1 ms. Such systems are connected to the PLC and/or control system level and receive their setpoint specifications from there.

The automation systems known from the prior art have a high assembly and cabling effort. Depending on the function (open-loop control/closed-loop control/safety), special cables are required, plus the bus connection and, in the case of safety-related requirements, possibly discrete cabling up to the control cabinet. Furthermore, the automation systems known from the prior art have a high effort along the entire engineering chain, for example in hardware engineering such as the creation of an E-plan. In addition to the complex planning, the automation systems known from the prior art can only be tested for proper functionality on site with a great deal of effort. Furthermore, calibration must take place and automation rules must be created in the PLC and control systems, which are managed centrally.

### SUMMARY

It is the object of the present disclosure to simplify the planning, installation and commissioning, along with the ongoing operation of automation systems for controlling a production process in a production plant in the metal production industry, the non-ferrous industry or the steel industry for producing semi-finished products or finished products.

The object is achieved by an automation system for controlling a production process in a production plant in the metal production industry, the non-ferrous industry or the steel industry for producing semi-finished products or finished products. The production plant comprises a plurality of plant parts for carrying out separate production steps. The automation system comprises, for each plant part, a separate control unit, for controlling actuators and/or sensors of the particular plant part for the purpose of automating the production step in the respective plant part. The separate control units of the automation system comprise wireless communication means for wirelessly communicating with one another.

In order to control the actuators and/or sensors of the plant part, corresponding information on the plant part to be controlled is expediently stored in the associated control unit. The control is based in particular on the data of the actuators and/or sensors and the production step to be carried out. Furthermore, mathematical models, expert knowledge or the like may be taken into account in this respect.

The individual plant parts each have a separate control unit that takes over the control of the actuators and/or sensors in the respective plant part. Thus, the automation of the production process in the production plant is carried out by decentralized intelligent control units. An intelligent control unit implements locally, that is, in the plant part, as many functions as possible of the control of the actuators and/or sensors in the respective plant part. The plant functions, regardless of their nature or origin, are carried out as far as possible locally in the plant part by the control unit in the plant part. Expediently, the control units are also arranged in the particular plant part, such that the control units are arranged in a decentralized manner throughout the production plant.

Since the carrying out of a production step in one plant part can depend on another production step in another plant part, in particular on the automation of the production step in the other plant part, the control units of the automation system comprise wireless communication means for wirelessly communicating with one another. Thus, the separate control units may exchange information with one another via the wireless communication means, if this is necessary and/or useful.

The use of wireless communications minimizes the amount of cabling required, which also significantly simplifies the planning and commissioning of the production plant. The wireless communication means are not limited in terms of transmission technology and are based, for example, on Bluetooth, Low-Energy Bluetooth, Near Field Communication (NFC), cellular standards such as 4G or 5G, Wireless Local Area Network (WLAN), or other known or future wireless transmission technologies.

In one variant, the automation system comprises a central control system, wherein the separate control units communicate with the central control system by means of the wireless communication means. In some production plants, it may be necessary for some aspects of the production process in the production plant to be controlled by a central control system. In this case, the central control system communicates with the separate control units in the plant parts via the wireless communication means. However, a central control system is only integrated if its function cannot be carried out locally by the separate control units.

In accordance with a preferred variant, each of the separate control units comprises a computing device. The computing device is, for example, a microcontroller, a programmable logic controller (PLC), or the like. By means of the computing device a multitude of control functions for the actuators and/or sensors of the corresponding plant part can be carried out.

According to an expedient variant, the separate control units comprise a power cable and/or an accumulator as the power supply.

In an advantageous variant, the separate control units at least partially comprise a protective housing. The protective housing provides the control units with better protection against external influences. This is particularly useful when used in a production plant in the metal production industry, the non-ferrous industry or the steel industry, as external influences in such plants could damage an unprotected control unit. The control units are formed as components appropriate for metal production plants. In some circumstances, the control units are explosion protected by the protective housings, if this is required.

In accordance with an advantageous variant, information on adjacent plant parts and/or information on the entire production plant and its plant parts is at least partially stored in the separate control units. Thus, the separate control units have at least partial knowledge of the structure of the entire production plant and thus also have information, for example, about how the previous and/or subsequent production step is formed.

According to a particularly preferred variant, the automation system is formed to be self-configuring, in particular self-networking. Given that the separate control units at least partially comprise information on adjacent plant parts and/or information on the entire production plant and its plant parts, the automation system can be formed to be self-configuring, in particular self-networking. This greatly simplifies setup and commissioning.

The object is further achieved by a method for controlling a production process in a production plant in the metal production industry, the non-ferrous industry or the steel industry for producing semi-finished products or finished products. The production plant comprises a plurality of plant parts for carrying out separate production steps. The method comprises the steps of: Controlling the automation of the production step in the plant parts by separate control units, in particular controlling actuators and/or sensors of the respective plant part, and exchanging data between the separate control units via wireless communication means.

Thereby, the separate control units preferably store at least partial information on the plant part to be controlled. The control is based in particular on the data of the actuators and/or sensors and the production step to be carried out. Furthermore, mathematical models, expert knowledge or the like may be taken into account in this respect.

The individual plant parts, in particular their actuators and/or sensors, are each controlled by a separate control unit. The automation of the production process in the production plant is thus decentralized. In particular, the control of the actuators and/or sensors is handled locally by intelligent control units in the respective plant part. An intelligent control unit implements locally, that is, in the plant part, as many functions as possible of the control of the actuators and/or sensors of the respective plant part. The plant functions, regardless of their nature or origin, are carried out as far as possible locally in the plant part by the control unit in the plant part. Expediently, the control units are also arranged in the particular plant part, such that the control units are arranged in a decentralized manner throughout the production plant.

Since the carrying out of a production step in one plant part may depend on another production step in another plant part, in particular on the automation of the production step in the other plant part, the method comprises the step of exchanging data between the separate control units of the automation system via wireless communication means. Thus, the separate control units exchange information wirelessly with one another, if this is necessary and/or useful.

The exchange of information via wireless communication minimizes the amount of cabling required, which also significantly simplifies the planning and commissioning of the production plant. The wireless communication means are not limited in terms of transmission technology and are based, for example, on Bluetooth, Low-Energy Bluetooth, Near Field Communication (NFC), cellular standards such as 4G or 5G, Wireless Local Area Network (WLAN), or other known or future wireless transmission technologies.

According to a variant, the method further comprises the step of exchanging data between the separate control units and a central control system. Data exchange between the central control system and the separate control units is also preferably wireless, in particular via the wireless communication means already available for communication between the separate control units. However, a central control system is only integrated if its function cannot be carried out locally by the separate control units.

In accordance with an advantageous variant, the data relevant for control are processed locally in the separate control units. For this purpose, the separate control units have, in particular, a computing device, such as a microcontroller, a programmable logic controller (PLC), or the like. Thus, the control of the production step in the plant part is preferably carried out locally by the separate associated control unit.

In an expedient variant, the separate control units at least partially store information on adjacent plant parts and/or information on the entire production plant and its plant parts. Thus, the separate control units have at least partial knowledge of the structure of the entire production plant and thus also have information, for example, about how the previous and/or subsequent production step is formed.

According to a particularly advantageous variant, the separate control units configure and/or network themselves independently. This is possible if the separate control units at least partially comprise information on adjacent plant parts and/or information on the entire production plant and its plant parts. By means of the wireless communication means, the separate control units may independently network with one another based on such information.

The invention is explained in more detail below with reference to an exemplary embodiment shown in the FIGURE.

### BRIEF DESCRIPTION OF THE DRAWINGS

FIG. 1 shows a schematic view of an embodiment of an automation system.

### DETAILED DESCRIPTION

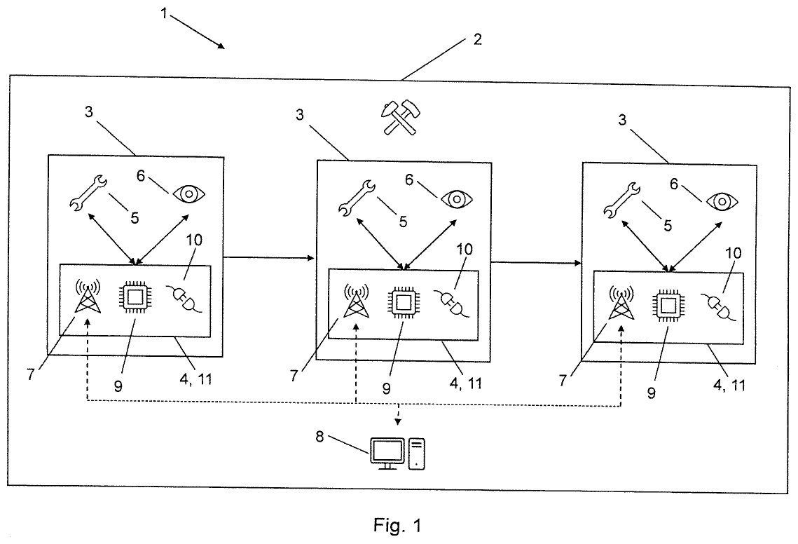

FIG. 1 shows a schematic view of an exemplary embodiment of an automation system 1 for controlling a production process in a production plant 2 in the metal production industry, the non-ferrous industry or the steel industry for producing semi-finished products or finished products. In general, the production plant 2 comprises a plurality of plant parts 3 for carrying out separate production steps. In accordance with the exemplary embodiment shown in FIG. 1, the production plant 2 comprises a total of three plant parts 3, which sequentially carry out separate production steps. The sequential order is shown by the arrows between the plant parts 3.

The automation system 1 comprises a separate control unit 4 for each plant part 3. The control unit 4 is formed to control actuators 5 and/or sensors 6 of the respective plant part 3 for the purpose of automating the production step in the respective plant part 3.

Each of the separate control units 4 of the automation system 1 comprises wireless communication means 7 for wirelessly communicating with one another. Wireless communication is symbolized by the dashed line in FIG. 1.

In accordance with the exemplary embodiment shown in FIG. 1, the automation system 1 or the production plant 2, as the case may be, comprises a central control system 8. The separate control units 4 may communicate with the central control system 8 by means of the wireless communication means 7, as also symbolized by the dashed line.

Furthermore, each of the separate control units 4 in accordance with the exemplary embodiment of FIG. 1 comprises a computing device 9. The computing device 9 is, for example, a microcontroller, programmable logic controller (PLC) or the like.

The separate control units 4 comprise a power cable 10 for power supply. Alternatively or additionally, the separate control units 4 may comprise an accumulator for power supply or as emergency power supply, as the case may be.

The separate control units 4 further comprise protective housings 11 in order to protect the components of the separate control units 4 from external influences. As a result, the separate control units 4 are formed to be appropriate for smelters and are suitable for production plants 2 in the metal production industry, the non-ferrous industry or the steel industry.

The separate control units 4 store, at least in part, information on adjacent plant parts 3 and/or information on the entire production plant 2 and its plant parts 3. This information enables, for example, the automation system 1 to be formed to be self-configuring, in particular self-networking.

The production process in a production plant 2 in the metal production industry, the non-ferrous industry or the steel industry for producing semi-finished products or finished products is controlled in that the separate control units 4 locally control the particular automations of the production steps in the plant parts 3. The separate control units 4 control in particular the respective actuators 5 and/or sensors 6 in the plant parts 3. Data may be exchanged between the separate control units 4 via the wireless communication means 7.

Via the wireless communication means 7, the separate control units 3 in accordance with the exemplary embodiment of FIG. 1 may also exchange data with the central control system 8.

The data relevant for control is preferably and as far as possible carried out locally in the particular separate control units 4. This is done, for example, by the particular computing device 9.

To control the production step in the particular plant part 3, corresponding information about the associated plant part 3 is stored in the separate control units 4. In particular, the separate control units 4 store, at least in part, information on adjacent plant parts 3 and/or information on the entire production plant 2 and its plant parts 3. With this stored information, the automation system 1 can configure itself and, in particular, the separate control units 4 can network themselves independently with one another.

### LIST OF REFERENCE SIGNS

1 Automation system
2 Production plant
3 Plant part
4 Control unit
5 Actuator
6 Sensor
7 Wireless communication means
8 Central control system
9 Computing device
10 Power cable/accumulator
11 Housing

1.-12. (canceled)

13. An automation system (1) for controlling a production process in a production plant (2) in the metal production industry, the non-ferrous industry or the steel industry for producing semi-finished products or finished products,
wherein the production plant (2) comprises a plurality of plant parts (3) for carrying out separate production steps,
wherein the automation system (1) comprises, for each plant part (3), a separate control unit (4) for controlling actuators (5) and/or sensors (6) of the respective plant part (3) for the purpose of automating the respective production step in the respective plant part (3), and
wherein the separate control units (4) of the automation system (1) comprise wireless communication means (7) for wirelessly communicating with one another.

14. The automation system (1) according to claim 13,
further comprising a central control system (8),
wherein the separate control units (4) communicate with the central control system (8) by means of the wireless communication means (7).

15. The automation system (1) according to claim 13,
wherein each of the separate control units (4) comprises a computing device (9).

16. The automation system (1) according to claim 13,
wherein the separate control units (4) comprise a power cable (10) and/or an accumulator as a power supply.

17. The automation system (1) according to claim 13,
wherein the separate control units (4) at least partially comprise a protective housing (11).

18. The automation system (1) according to claim 13,
wherein the separate control units (4) at least partially store information on adjacent plant parts (3) and/or information on the entire production plant (2) and its plant parts (3).

19. The automation system (1) according to claim 18,
wherein the automation system (1) is formed to be self-configuring and self-networking.

20. A method for controlling a production process in a production plant (2) in the metal production industry, the non-ferrous industry or the steel industry for producing semi-finished products or finished products, wherein the production plant (2) comprises a plurality of plant parts (3) for carrying out separate production steps, comprising the steps of:
controlling an automation of the production step in the plant parts (3) by separate control units (4), in particular controlling actuators (5) and/or sensors (6) of the respective plant part (3); and
exchanging data between the separate control units (4) via wireless communication means (7).

21. The method according to claim 20,
further comprising the step of exchanging data between the separate control units (4) and a central control system (8).

22. The method according to claim 20,
wherein the data relevant for control are processed locally in the separate control units (4).

23. The method according to claim 20,
wherein the separate control units (4) at least partially store information on adjacent plant parts (3) and/or information on the entire production plant (2) and its plant parts (3).

24. The method according to claim 23,
wherein the separate control units (4) configure themselves and network themselves independently with one another.
